(19) United States
(12) Patent Application Publication
(10) Pub. No.: US 2026/0163983 A1
(43) Pub. Date: Jun. 11, 2026

(54) INFORMATION PROCESSING APPARATUS, IMAGE FORMING APPARATUS, CONTROL METHOD, AND STORAGE MEDIUM

(71) Applicant: CANON KABUSHIKI KAISHA, Tokyo (JP)

(72) Inventor: MASASHI YURI, Chiba (JP)

(21) Appl. No.: 19/179,587

(22) Filed: Apr. 15, 2025

(30) Foreign Application Priority Data
Apr. 19, 2024 (JP) 2024-067931
Oct. 7, 2024 (JP) 2024-176189

(51) Int. Cl. H04N 1/00; G06F 3/12; H04N 1/44

(52) U.S. Cl. CPC H04N 1/00029; G06F 3/1207; G06F 3/121; G06F 3/1234; H04N 1/00076; H04N 1/00079; H04N 1/00413; H04N 1/00464; H04N 1/00477; H04N 1/4426; H04N 2201/0094

(57) ABSTRACT

An information processing apparatus includes at least one processor and at least one memory that is in communication with the at least one processor. The at least one memory stores instructions for causing the at least one processor and the at least one memory to execute a diagnosis of a trouble with the information processing apparatus, control a display device to display a result of the diagnosis and a two dimensional code for displaying information on the result of the diagnosis, and after the result of the diagnosis is displayed, transmit access information for displaying a page for providing information on the result of the diagnosis to a set transmission destination via a network.

### BACKGROUND

### Field of the Disclosure

The present disclosure relates to an information processing apparatus including an image processing apparatus capable of diagnosing a trouble with the apparatus.

### Description of the Related Art

When a user performs printing using a multi-function peripheral (MFP), a trouble may occur in which a printed product fails to be normally output or an output product is not one as expected even when the printing is normally finished. In such a case, the cause of the trouble is identified through diagnosis, and the cause is provided to the user. When the cause of the trouble is provided to the user, the information processing apparatus displays a two dimensional code. By reading the two dimensional code with a mobile terminal or another type of device, the user can operate the information processing apparatus to fix the trouble while viewing the cause on the terminal (U.S. Pat. No. 10,521,176).

As in U.S. Pat. No. 10,521,176, displaying a two dimensional code for fixing a trouble with an information processing apparatus allows the trouble with the information processing apparatus to be fixed while the user is viewing a solution displayed on a mobile terminal. In this case, for example, if the user does not carry a device for reading the two dimensional code with them, the user may not be able to operate the information processing apparatus while viewing the solution. Additionally, it may be more convenient for some users to operate a system that allows them to select a method of checking a solution.

### SUMMARY

According to an aspect of the present disclosure, an information processing apparatus includes at least one processor and at least one memory that is in communication with the at least one processor. The at least one memory stores instructions for causing the at least one processor and the at least one memory to execute a diagnosis of a trouble with the information processing apparatus, control a display device to display a result of the diagnosis and a two dimensional code for displaying information on the result of the diagnosis, and after the result of the diagnosis is displayed, transmit access information for displaying a page for providing information on the result of the diagnosis to a set transmission destination via a network.

Further features of various embodiments will become apparent from the following description of exemplary embodiments with reference to the attached drawings.

### BRIEF DESCRIPTION OF THE DRAWINGS

FIG. 1 is a block diagram illustrating an example of a hardware configuration of an image forming apparatus according to a first exemplary embodiment.

FIG. 2 is a diagram illustrating an example of a software configuration of the image forming apparatus.

FIG. 3 is a flowchart of a process of leaving information on a job in a job log at the time of printing.

FIG. 4 is a diagram illustrating an example of the job log.

FIG. 5 is a diagram illustrating an example of a screen of a top menu for performing trouble diagnosis on the job.

FIG. 6 is a diagram illustrating an example of a screen on which candidate jobs for a printing trouble are displayed.

FIG. 7 is a flowchart of a process of displaying the candidate jobs for the printing trouble.

FIG. 8 is a diagram illustrating a candidate job extraction table for the printing trouble.

FIG. 9 is a flowchart illustrating a diagnosis process on a selected job in the first exemplary embodiment.

FIG. 10 is a diagram illustrating a countermeasure list for printing troubles.

FIG. 11 is a diagram illustrating an example of a screen on which candidates for a countermeasure and details of the selected countermeasure are displayed in the first exemplary embodiment.

FIG. 12 is a diagram illustrating an example of a flowchart when a button for a case where a two dimensional code cannot be read is pressed.

FIGS. 13A to 13C are each a diagram illustrating an example of a pop-up display when the button for a case where a two dimensional code cannot be read is pressed.

FIG. 14 is a flowchart illustrating details of a transmission destination setting process.

FIGS. 15A to 15C are each a diagram illustrating details of the transmission destination setting process in a pop-up.

FIGS. 16A and 16B illustrate example sites for troubleshooting.

FIG. 17 is a diagram illustrating an example of a details display section displayed via a remote user interface (UI).

FIG. 18 is a diagram illustrating an example of a screen on which a plurality of buttons for checking candidates for countermeasures and details of the selected countermeasure are displayed in the first exemplary embodiment.

FIG. 19 is a diagram illustrating an example of a flowchart when a details button for a diagnosis result is switched.

FIG. 20 is a diagram illustrating an example of a flowchart when a details button for a diagnosis result is switched according to job information.

FIG. 21 is a diagram illustrating an example of a flowchart when a details button for a diagnosis result is switched according to a diagnosis result.

FIG. 22 is a diagram illustrating an example of a screen for setting display of a diagnosis result.

FIG. 23 is a diagram illustrating an example of a settings screen when a diagnostic result screen settings button is pressed.

### DESCRIPTION OF THE EMBODIMENTS

Hereinafter, a first exemplary embodiment will be described with reference to the drawings.

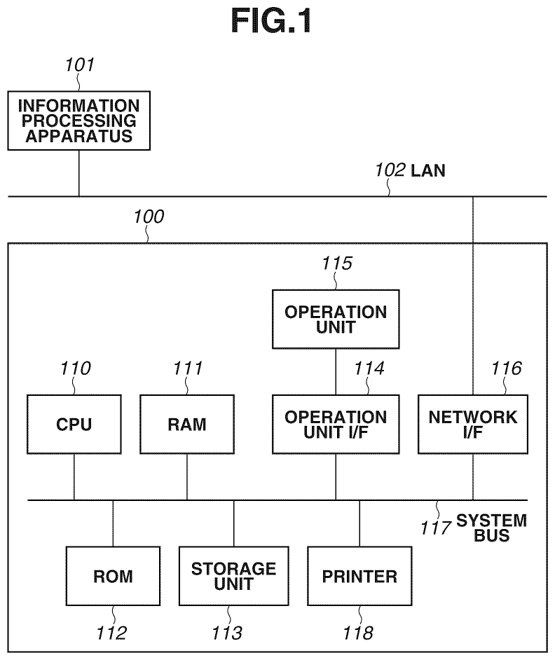

FIG. 1 is a diagram illustrating a configuration example of a printing system according to the present exemplary embodiment. In this system, two information processing apparatuses 101 and 100 are connected via a local area network (LAN) 102. The information processing apparatuses 101 and 100 are capable of network communication with each other. In the present exemplary embodiment, the information processing apparatus 100 is an image forming apparatus having a print function. The information processing apparatus 100 will be described as the image forming apparatus 100. The information processing apparatus 101 will be described as another apparatus different from the image forming apparatus 100.

A user generates print data in the information processing apparatus 101, and transmits the print data from the information processing apparatus 101 to the image forming apparatus 100 via the LAN 102. The image forming apparatus 100 according to the present exemplary embodiment may be a multi-function peripheral (MFP) or a single-function printer (SFP). A printer having a plurality of functions, such as fax, copy, print, and scan functions, is referred to as an MFP, and a printer having only a print function as an SFP.

### Hardware Configuration of Image Forming Apparatus

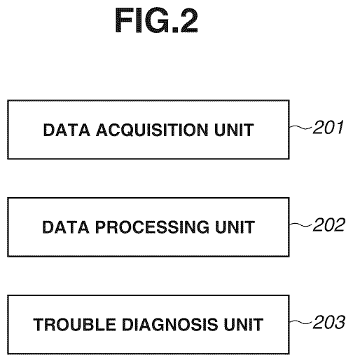

An example of a hardware configuration of the image forming apparatus 100 according to the first exemplary embodiment will be described with reference to FIG. 1. A central processing unit (CPU) 110 is a control center of the image forming apparatus 100 that integrally performs the control of the devices connected to a system bus 117. A random access memory (RAM) 111 is a storage device accessible by the CPU 110, and is used as a working memory for the CPU 110 to operate with in the present exemplary embodiment. A read-only memory (ROM) 112 stores programs, and the CPU 110 loads the programs onto the RAM 111 and executes the programs, whereby each software module illustrated in FIG. 2, which will be described below, operates. A storage unit 113 is, for example, a hard disk drive that stores system software for various processes, acquired print data, and the like. In addition, authentication information on a user and an email address is registered in the storage unit 113 in advance by an administrator.

An operation unit interface (I/F) 114 is used for an operation unit 115 including a display section for displaying various menus, information relating to print data instructed to be printed, and the like, and outputs operation screen data to the operation unit 115. The operation unit I/F 114 transmits information input by the user via the operation unit 115 to the CPU 110. A network I/F 116 is used for exchanging information with other apparatuses, such as the information processing apparatus 101, via the LAN 102. In the present exemplary embodiment, page description language (PDL) data is received as print data from an external device. A printer 118 is a print engine that performs printing on recording media (paper sheets, etc.) in accordance with PDL interpreted by the CPU 110.

FIG. 2 is a diagram illustrating an example of a software configuration of the image forming apparatus 100. The image forming apparatus 100 includes software modules 201 to 203 illustrated in FIG. 2. As described above, these software modules 201 to 203 is operated by the CPU 110 executing programs loaded from the ROM 112 to the RAM 111. The data acquisition unit 201 receives PDL data. The data processing unit 202 interprets the received PDL data to execute print processing. Further, information on the PDL data and information on the printing outcome are left in the job log. The trouble diagnosis unit 203 narrows down a candidate or candidates for a countermeasure or countermeasures for a trouble based on the trouble information and the job log, and displays the candidate(s) on the operation unit 115. Further, the countermeasure(s) is or are displayed on the operation unit 115 based on the selected countermeasure candidate(s).

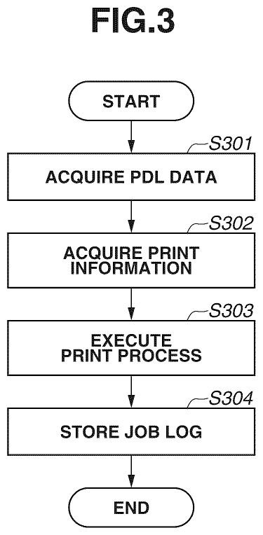

FIG. 3 is a flowchart illustrating a flow of processing from PDL data acquisition to execution of print processing and storage of a job log, all of which are performed by the CPU 110. The flowchart will now be described.

In step S301, the data acquisition unit 201 acquires PDL data via the network I/F 104. Also, PDL data may be acquired from the storage unit 113 of the image forming apparatus 100. In step S302, the data acquisition unit 201 acquires print information. The print information is related to the acquired PDL data, and the print information is used in print processing on PDL data or is left in a job log. Examples of the print information include information about an operating system (OS), a driver, and an application used for generating PDL data, and driver setting information, such as a sheet size, a sheet type, and a page layout. The CPU 110 analyzes the PDL to acquire the print settings attached to the PDL. Also, the CPU 110 may acquire print settings stored in the storage unit 113 of the image forming apparatus 100. Information about an OS and an application used for generating PDL data can be acquired from PDL data to which OS and application information is attached, or can be acquired separately from PDL data via the network I/F 104.

In step S303, the data processing unit 202 executes print processing. In the print processing, first, the acquired PDL data is analyzed, and as many pieces of intermediate data as the number of pages is generated. Next, as an image forming process, a raster image processor (RIP) process is executed to convert the generated pieces of intermediate data into an image in raster format. Thereafter, the CPU 110 performs image processing on the image in the raster format, and the printer 118 prints the rasterized image after the image processing on a recording material. In step S304, the data processing unit 202 performs processing for saving a job log. In the job log storage processing, information related to the PDL data for which the print processing has been executed is stored in the storage unit 113 as a job log. The data processing unit 202 constructs a job log database (DB) in the storage unit 113, and stores the created job log in the job log DB together with a past job log.

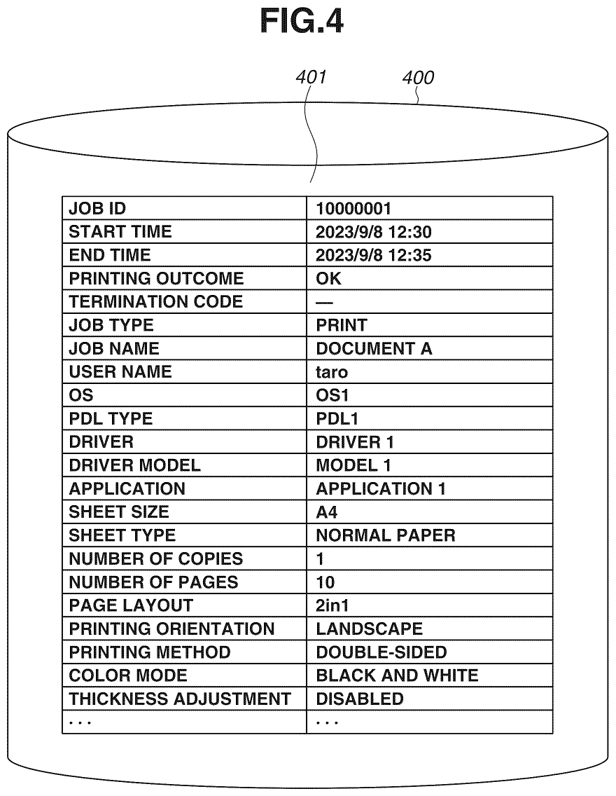

FIG. 4 illustrates an example of the job log DB and the job log. FIG. 4 illustrates a job log DB 400 and an example of a job log 401. The job log stores, for example, information acquired before the start of the print processing and a printing outcome. Specific items of the job log 401 will be described.

Job ID is a unique value that identifies a job.

Start time is the time when print processing is started.

End time is the time when print processing is ended.

Printing outcome is a value indicating the outcome of printing processing: Successful when the processing is normally ended, and Failed when the processing is abnormally ended.

Termination code is an identification number for checking an error message when the printing outcome is determined to be Failed. If the printing outcome is Successful, “-” is set.

Job type represents a type of job, such as fax, copy, print, or scan.

Job name represents the name of a printed file.

User name represents the name of a user who executed printing.

OS indicates the OS, such as OS1 or OS2, on the terminal on which a user has executed printing.

PDL type represents a type of PDL, such as PDL1 or PDL2.

Driver indicates the name of a driver used for printing. If no driver is used in direct printing, “-” is set.

Driver model indicates a model applied to a driver used for printing.

Application indicates the name of an application on which printing is executed.

Paper size indicates a paper size, such as A4, B4, or postcard.

Paper type indicates a paper type, such as plain paper, thick paper, or an envelope.

Number of copies indicates the number of copies printed of the same content.

Number of pages indicates the number of pages of PDL data.

Page layout indicates settings, such as N-up printing.

Printing orientation indicates the setting of portrait or landscape orientation.

Printing method indicates the setting of single-sided or double-sided printing.

Color mode indicates the setting of color, black and white, or automatic color.

Thickness adjustment indicates the setting for thickening a character, a line, a graphic, or the like.

The items to be left in the job log introduced here are merely examples, and the present exemplary embodiment is not limited to these. The job log DB 400, which stores job logs of jobs, is used in displaying a job history, diagnosing a printing trouble (a problem), and for other purposes.

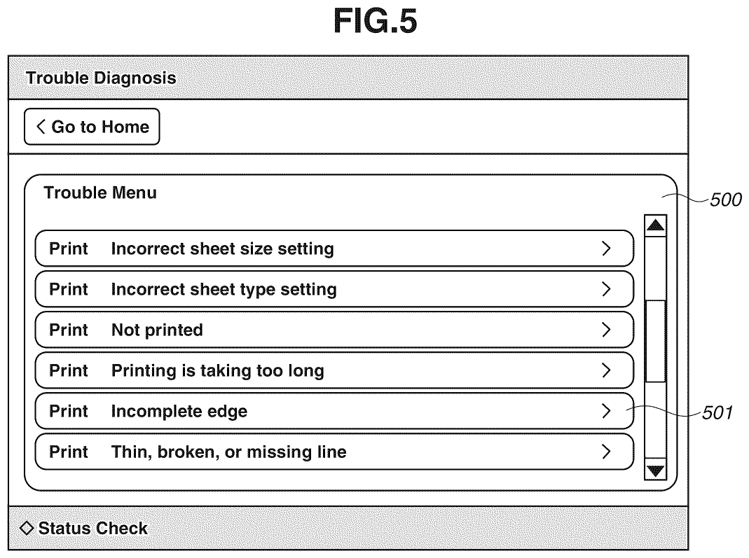

FIG. 5 is a diagram illustrating an example of a top menu for diagnosing a job in which a trouble (a problem) has occurred. A trouble menu 500 is a display area for displaying items in diagnostic contents. A diagnostic content in the trouble menu 500 can be selected.

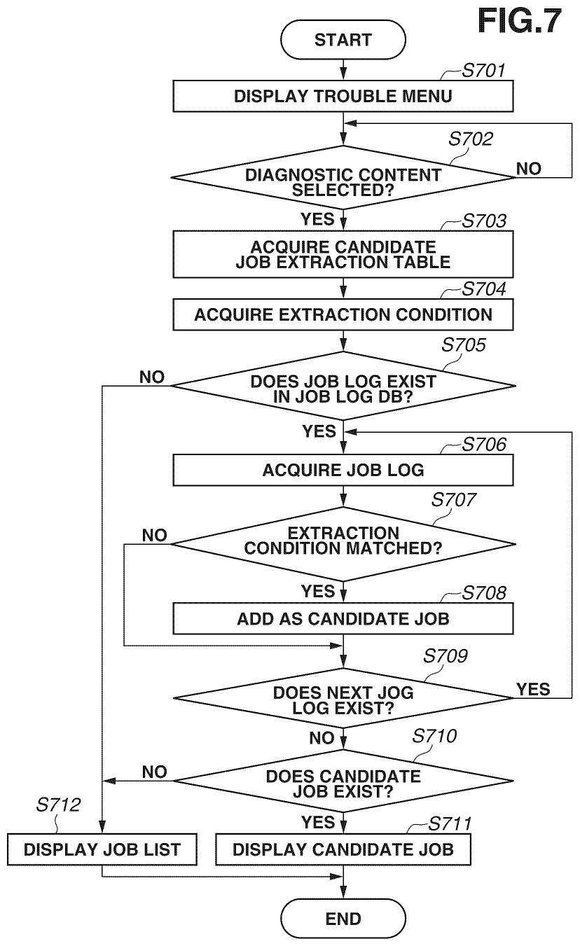

Here, as an example, candidate job display in a case where a diagnostic content of “incomplete edge” 501 in the “print” function is pressed will be described using FIGS. 5 to 8. FIG. 7 is a flowchart illustrating a flow of a candidate job display process executed by the CPU 110.

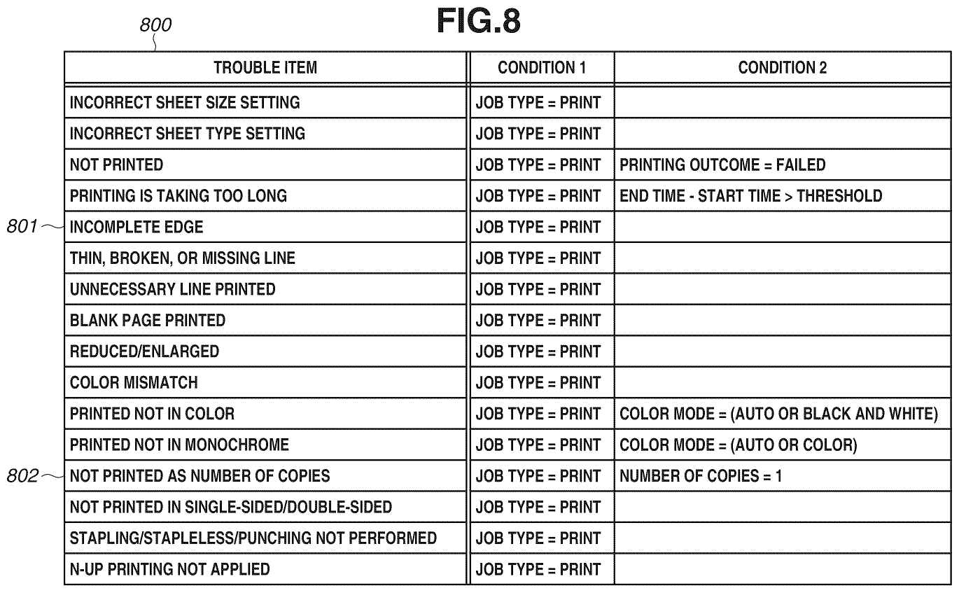

In step S701, the trouble diagnosis unit 203 displays the trouble menu 500 of FIG. 5. In step S702, when the CPU 110 detects that a diagnostic content is selected (receiving unit) (YES in step S702), the processing proceeds to step S703. In step S703, the trouble diagnosis unit 203 acquires a candidate job extraction table 800 of FIG. 8.

If the CPU 110 detects a press of the “incomplete edge” 501, in step S704, the trouble diagnosis unit 203 acquires a candidate job extraction condition for the “incomplete edge” 801 from the candidate job extraction table 800. The candidate job extraction condition for “incomplete edge” 801 corresponds to a job whose value of the job type matches “print”.

In step S705, the trouble diagnosis unit 203 checks whether a job log exists in the job log DB 400. If one or more job logs exist (YES in step S705), the processing proceeds to step S706. In step S706, the trouble diagnosis unit 203 acquires one job log from the job log DB 400. In step S707, the trouble diagnosis unit 203 checks whether the acquired job log matches the extraction condition. If the extraction condition is matched (YES in step S707), the processing proceeds to step S708.

If the extraction condition is not matched (NO in step S707), the processing proceeds to step S709.

In step S708, when the extraction condition is matched, the trouble diagnosis unit 203 adds the corresponding job as a candidate job. For example, the candidate job extraction condition for the “incomplete edge” 801 corresponds to a job whose value of the job type matches “print”, and the job log 401 matches the condition, and therefore, the job is extracted as a candidate job.

In step S709, the trouble diagnosis unit 203 checks whether there is a job log in the job log DB 400 that has not been compared with the extraction condition. If there is a job log that has not been compared (YES in step S709), the processing returns to step S706 to acquire another job log, and the processing in steps S707 and S708 are repeated. If there is no job log that has not been compared (NO in step S709), the processing proceeds to step S710.

In step S710, the trouble diagnosis unit 203 checks whether there is a candidate job that matches the condition.

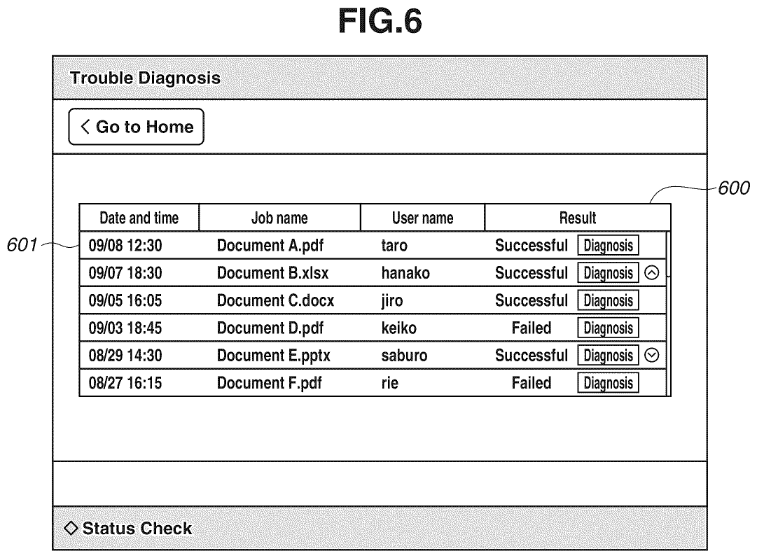

If there is a candidate job (YES in step S710), the processing proceeds to step S711, and candidate jobs are displayed on a candidate job display section 600 illustrated in FIG. 6 in the operation unit 115. If no job log exists (NO in step S705) and if no candidate job exists (NO in step S710), the processing proceeds to step S712. In step S712, the job(s) stored in the job log DB 400 is or are displayed in a list as much as possible, and the process ends. The jobs may be arranged in the order of storage in the job, and are not limited to this order.

While the extraction of the trouble candidate job for the “incomplete edge” 801 is exemplified here, the extraction method is similar even when other diagnostic contents are selected. For example, if a trouble “Not printed as the number of copies” 802 is selected, the extraction is performed according to the conditions for the “Not printed as the number of copies” 802. All the jobs with “print” as the job type value and “1” as the number of copies value are acquired from the job log DB 400 and displayed.

As described above, the candidate job extraction is performed according to the conditions of the candidate job extraction table 800 of FIG. 8. However, while the method of extracting a candidate job using a condition or conditions associated with the trouble has been described, a candidate job may be extracted in combination with a condition not associated with the trouble (extracting 50 most recent jobs, extracting from the jobs of the login user, etc.). The conditions associated with a trouble are not limited to those above.

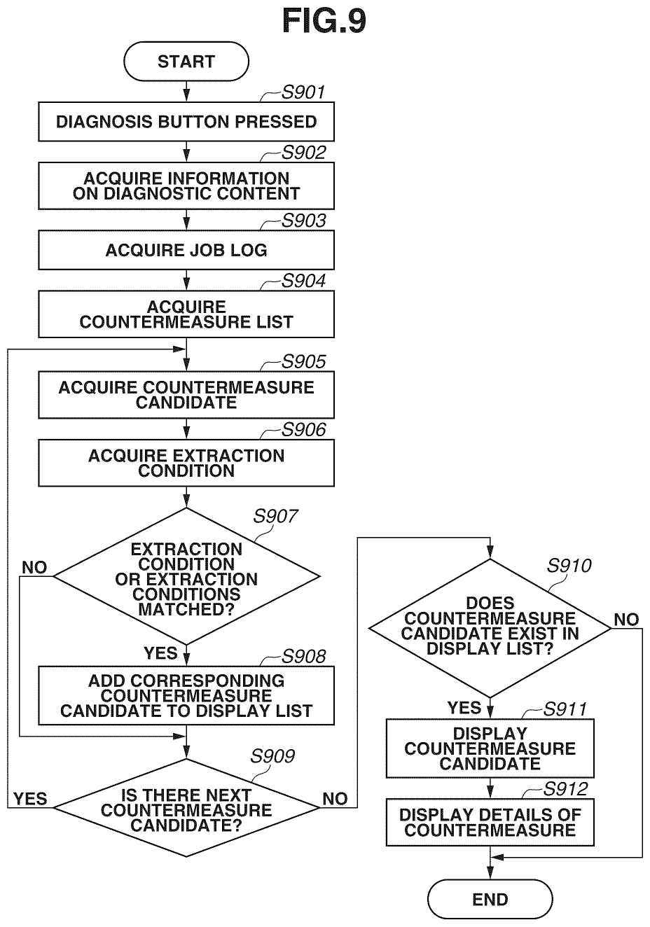

The display of countermeasures when a diagnosis is performed will be described with reference to FIGS. 9 to 11 by taking as an example a case where the trouble information of the “incomplete edge” 501 and a job 601 are received by the receiving unit.

FIG. 9 is a flowchart for diagnosis processing in which the trouble diagnosis unit 203 diagnoses the information processing apparatus based on a selected diagnostic content and a job. In step S901, the trouble diagnosis unit 203 detects that the diagnosis button of the job 601 is pressed after the diagnostic content of the “incomplete edge” 501 is selected. And, in step S902, the trouble diagnosis unit 203 acquires the information on the diagnostic content. In this case, the trouble diagnosis unit 203 acquires the trouble “incomplete edge” as the diagnostic content. In step S903, the trouble diagnosis unit 203 acquires a job log corresponding to the selected job. In this case, the trouble diagnosis unit 203 acquires the job log 401 corresponding to the job 601.

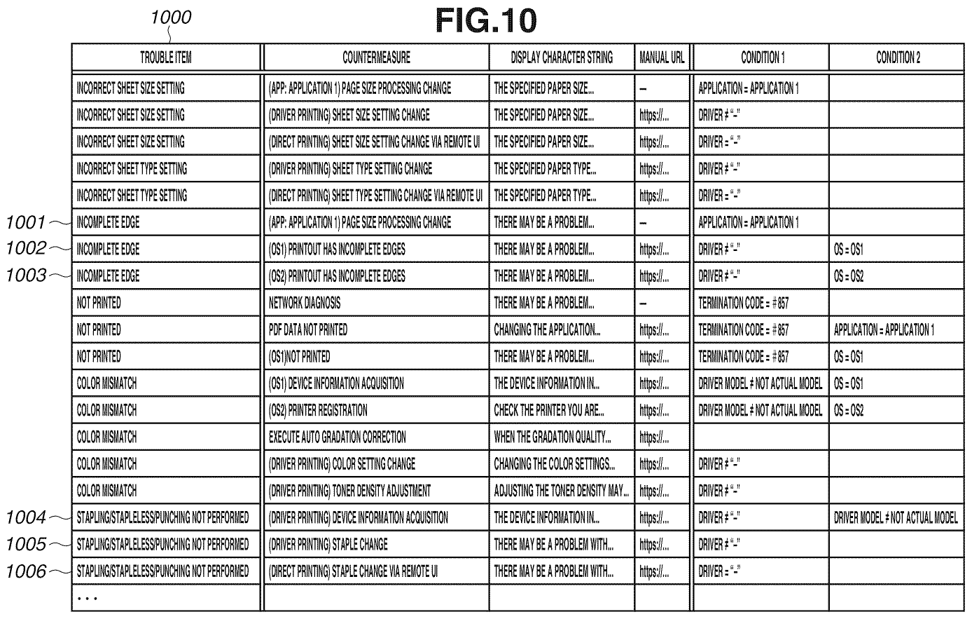

In step S904, the trouble diagnosis unit 203 acquires a countermeasure list 1000 in FIG. 10. In step S905, the trouble diagnosis unit 203 acquires one countermeasure candidate from the countermeasure list 1000, and in step S906, the trouble diagnosis unit 203 acquires an extraction condition or extraction conditions for determining what to extract as the countermeasure candidate.

In step S907, the trouble diagnosis unit 203 checks whether the acquired job log 401 matches the extraction condition(s). If the extraction condition or the extraction conditions is or are matched (YES in step S907), the processing proceeds to step S908. In step S908, the trouble diagnosis unit 203 adds the corresponding countermeasure candidate to the display list, and the processing proceeds to step S909. If the extraction condition or all the extraction conditions is or are not matched (NO in step S907), the processing proceeds to step S909. In step S909, the trouble diagnosis unit 203 checks whether there is another countermeasure candidate that has not been compared. If there is a countermeasure candidate that has not been compared (YES in step S909), the processing returns to step S905 to acquire another countermeasure candidate, and the processing in steps S906 to S908 are repeated. If there is no countermeasure candidate that has not been compared (NO in step S909), the processing proceeds to step S910.

For the “incomplete edge” selected as the diagnostic content, countermeasure candidates 1001 to 1003 of the countermeasure list 1000 correspond to the countermeasure candidates. The job log 401 is compared with each of the extraction conditions for the countermeasure candidates 1001 to 1003.

The extraction condition for the countermeasure candidate 1001 for “(app: application 1) page size processing change” is “application=application 1”. In the job log 401, “application 1” is recorded as application information. Therefore, the condition “application=application 1” is matched, and the countermeasure candidate 1001 is added to the display list.

The extraction conditions for the countermeasure candidate 1002 for “(OS1) printout has incomplete edges” are “driver≠‘-’” and “OS=OS1”. In the job log 401, “driver 1” is recorded as driver information and “OS 1” is recorded as OS information. Therefore, the conditions “driver≠‘-’” nd “OS=OS1” are matched, and the countermeasure candidate 1002 is added to the display list.

The extraction conditions for the countermeasure candidate 1003 for “(OS2) printout has incomplete edges” are “driver≠‘-’” and “OS=OS2”. In the job log 401, the condition “OS=OS2” is not matched. Therefore, the countermeasure candidate 1003 is not added to the display list. Finally, the countermeasure candidates 1001 and 1002 are added to the display list.

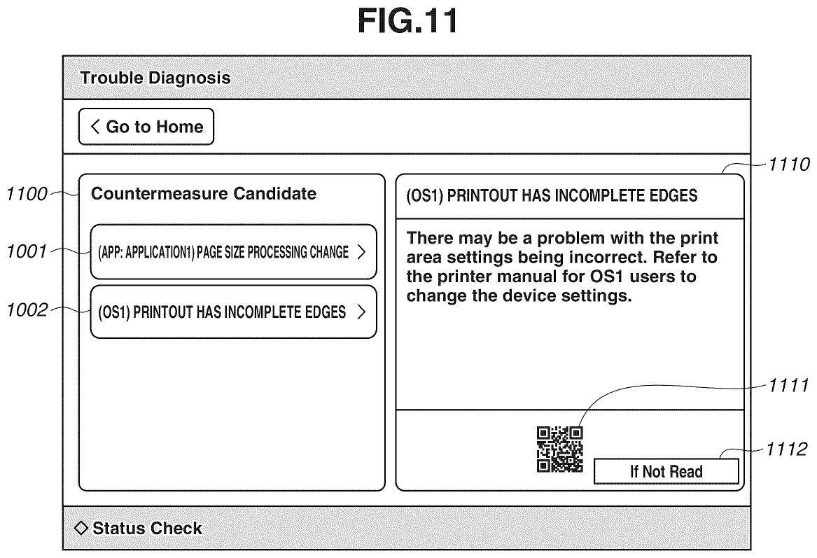

In step S910, the trouble diagnosis unit 203 checks whether there is a countermeasure candidate in the display list. If there is a countermeasure candidate (YES in step S910), the processing proceeds to step S911. In step S911, the diagnostic result is displayed on the display section 1100 illustrated in FIG. 11 in the operation unit 115. The diagnosis result includes a countermeasure candidate or countermeasure candidates. Here, two countermeasure candidates are displayed. In step S912, if a press of a “(OS1) printout has incomplete edges” 1002 is detected, the trouble diagnosis unit 203 displays detailed information about the selected countermeasure on a details display section 1110. Specifically, the details display section 1110 displays an image 1111 and a button 1112. The image 1111 is a two dimensional code into which the character string of the countermeasure candidate 1002 for “(OS1) printout has incomplete edges” and a uniform resource locator (URL) indicating the content of troubleshooting are converted. The URL is an example of access information, and other access information, such as another type of path information, may be used as long as a page for providing information related to a diagnosis result can be displayed on a desired apparatus.

The details display section 1110 may include a search key for searching for a detailed method in a text indicating the outline of a countermeasure. The contents are merely examples, and the present exemplary embodiment is not limited to these.

While the example has been described in which the countermeasure candidates are extracted when the job 601 is selected in the case of “incomplete edge”, the method of extracting a countermeasure candidate in a case where a combination of another diagnostic content and another job is selected is similar to the foregoing method. For example, when the job 601 is selected with “stapling/stapleless/punching not performed”, the conditions for countermeasure candidates 1004 to 1006 corresponding to “stapling/stapleless/punching not performed” in the countermeasure list 1000 are compared and extracted. Each condition is compared with the information on the job log 401 corresponding to the job 601, and finally, the countermeasure candidates 1005 and 1006 are added to the display list and displayed.

As described above, when “stapling/stapleless/punching not performed” is selected, the countermeasure candidates related to “stapling/stapleless/punching not performed” and the countermeasure candidate related to the selected job are displayed.

As illustrated in FIG. 11, the diagnosis result is displayed on the display section. In this case, it is often not practical to display a detailed solution and detailed cause on the display section due to the data capacity and other factors.

Consequently, an image is displayed on the display section as a two dimensional code into which a URL indicating a troubleshooting content is converted. The user reads the two dimensional code with a device, such as a mobile terminal, and displays the corresponding content. At this time, the user does not always carry a device capable of reading the two dimensional code with them. Thus, an apparatus is used which can present a detailed countermeasure or detailed countermeasures and a solution or solutions even to a user who cannot make use of a two dimensional code. The following is a description of details of a configuration for such an issue.

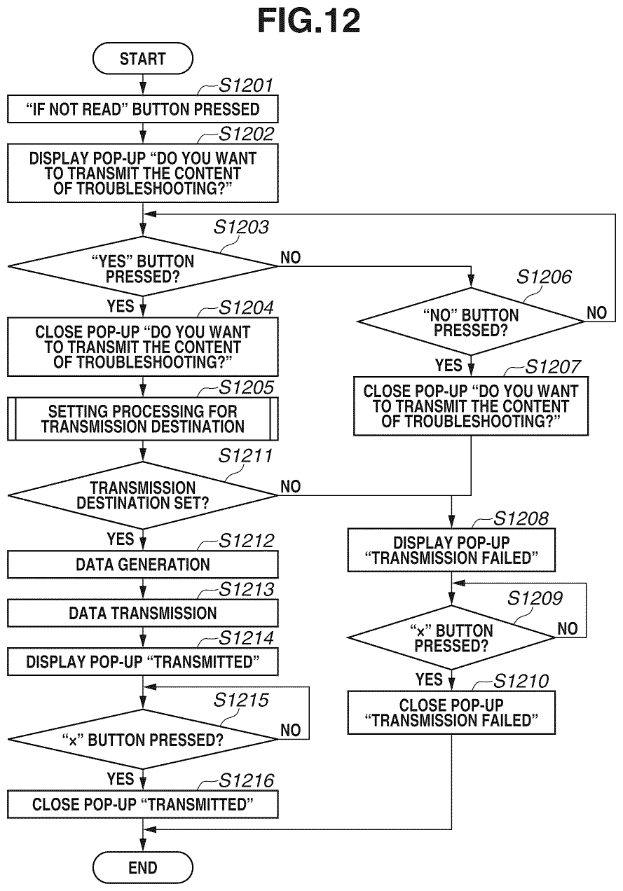

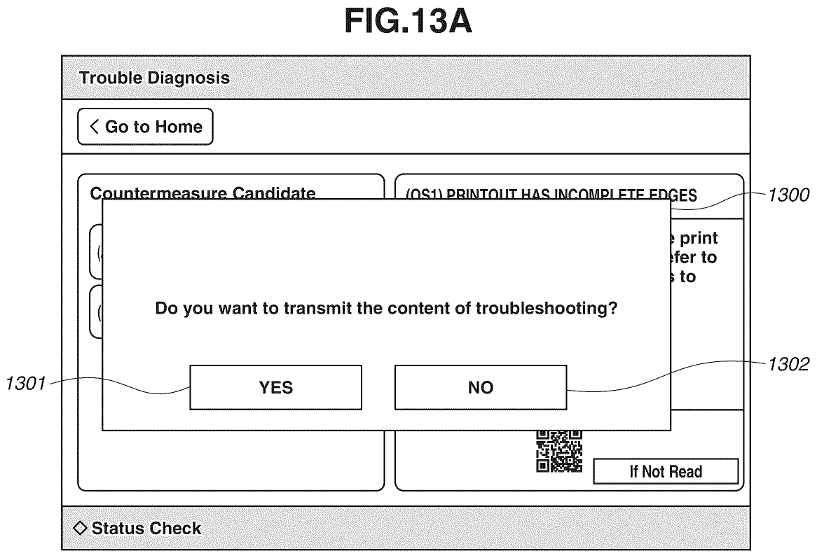

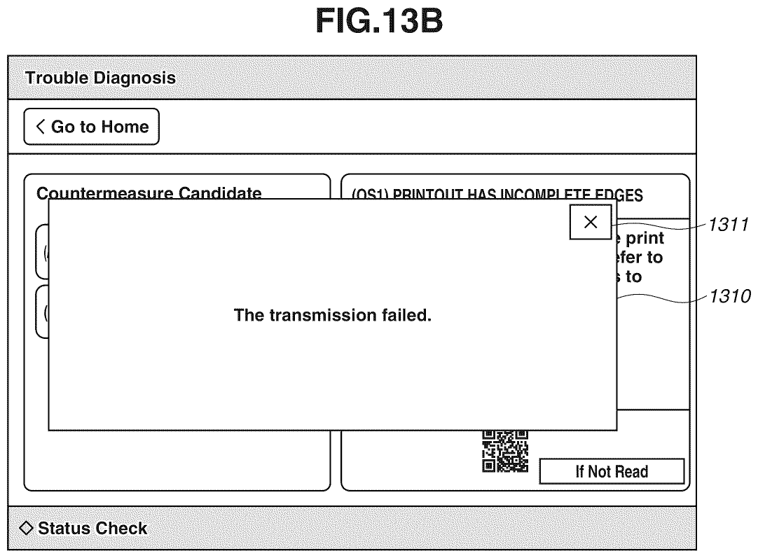

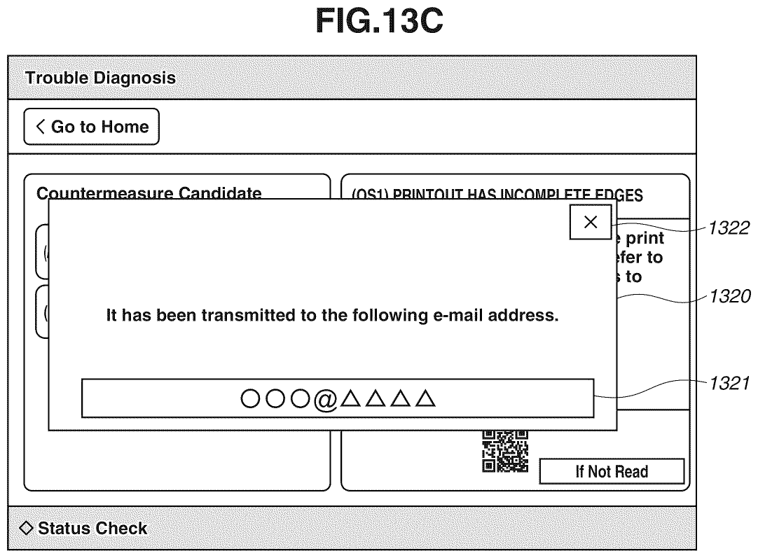

The button 1112 is displayed on the diagnostic result as illustrated in FIG. 11. The button 1112 is used for a user who does not have a device capable of reading a two dimensional code with them. A case where the button 1112 is selected will be described with reference to a flowchart illustrated in FIG. 12 and FIGS. 13A to 13C.

In step S1201, the CPU 110 detects that the button 1112 for the case where the two dimensional code cannot be read is pressed, and in step S1202, the CPU 110 displays a pop-up 1300 for prompting transmission, such as “Do you want to transmit the content of troubleshooting?”. Next, the CPU 110 detects that a “YES” button 1301 is pressed from the pop-up displayed in step S1202 (YES in step S1203), the processing proceeds to step S1204, and after the pop-up 1300 is closed in step S1204, the process of setting a transmission destination is performed in step S1205. Details regarding the processing in step S1205 will be described below. In step S1203, if the CPU 110 does not detect that the “YES” button 1301 is pressed from the pop-up displayed in step S1202 (NO in step S1203), the processing proceeds to step S1206. In step S1206, the CPU 110 detects whether a “NO” button 1302 is pressed. In step S1206, if the CPU 110 detects that the “NO” button 1302 is pressed (YES in step S1206), the processing proceeds to step S1207. In step S1207, the pop-up 1300 is closed, and in step S1208, a pop-up 1310 “The transmission failed” is displayed. In step S1209, the CPU 110 detects whether a “x” button 1311 is pressed, and if the CPU 110 detects that the “x” button 1311 is pressed (YES in step S1209), the processing proceeds to step S1210. In step S1210, the pop-up 1310 is closed. The pop-up 1300 is continuously displayed until one of the buttons 1301 and 1302 is pressed, and the pop-up 1310 is continuously displayed until the “x” button 1311 is pressed.

On the other hand, in step S1211, the CPU 110 determines whether a transmission destination is set, and if the CPU 110 determines that a transmission destination is set (YES in step S1211), the processing proceeds to step S1212. In step S1211, if the CPU 110 determines that no transmission destination is set (NO in step S1211), the processing proceeds to step S1208, and in step S1208, the pop-up 1310 “The transmission failed” is displayed. In step S1212, the CPU 110 generates data indicating a trouble shooting content, and in step S1213, the CPU 110 transmits the data to the information processing apparatus 101 based on the information on the email address set in step S1205. In step S1214, the CPU 110 displays a pop-up 1320 illustrating an expression like “Transmitted” and displays an email address 1321 as the transmission destination set in step S1205. In step S1215, the CPU 110 detects whether a “x” button 1322 is pressed. If a press of the “x” button 1322 is detected (YES in step S1215), the processing proceeds to step S1216, and in step S1216, the pop-up 1320 is closed. The pop-up 1320 is continuously displayed until the “x” button 1322 is pressed.

Further, the data generated in step S1212 may be, for example, a URL that allows direct transition to troubleshooting or a URL that illustrates a list of troubleshooting. For example, the data on an electronic manual indicating the contents of troubleshooting may be transmitted, or image data obtained by capturing the contents of troubleshooting or text data directly indicating the contents of troubleshooting may be transmitted, and the present exemplary embodiment is not limited to a specific form. The contents of the displayed pop-ups are merely examples, and the present exemplary embodiment is not limited to these. Furthermore, the displayed screen may be provided on the image forming apparatus 100 or on the information processing apparatus 101. Display examples and screens of troubleshooting will be described in detail below.

On the other hand, the transmission of a URL is more favorable than, for example, captured image data because the data capacity held by the information processing apparatus 101 can be reduced. The user can directly access a solution of a trouble by transmitting a URL corresponding to a diagnosis result based on a countermeasure candidate selected in FIG. 11.

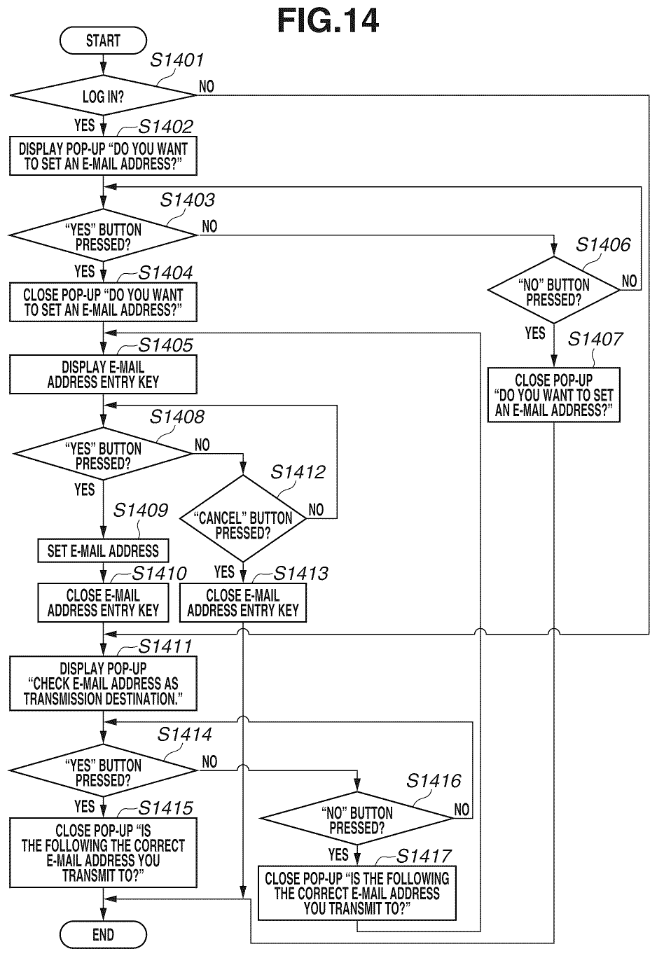

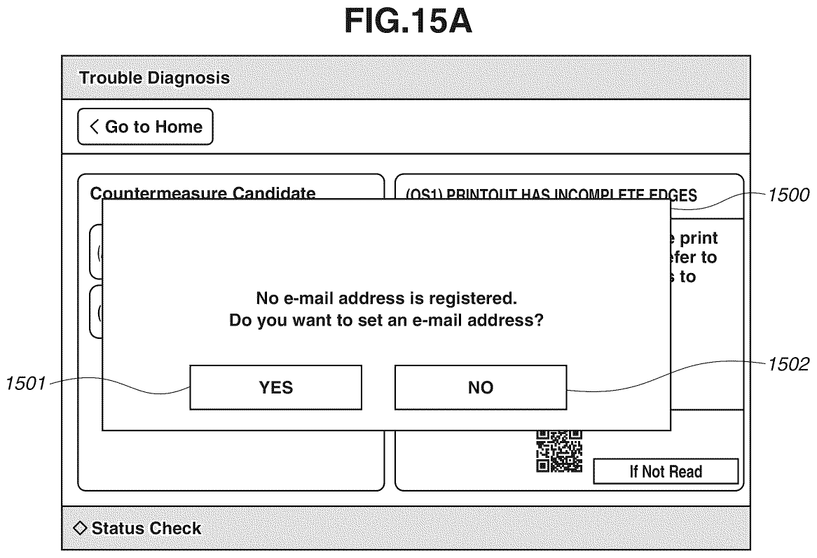

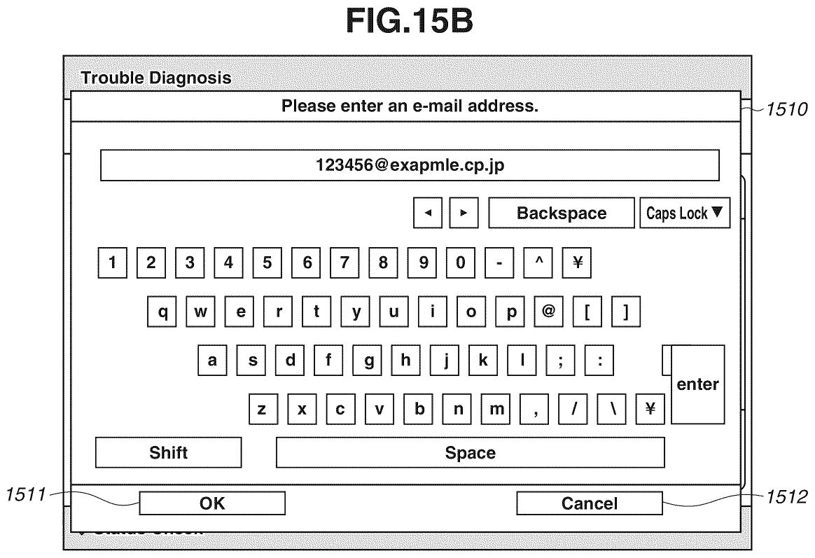

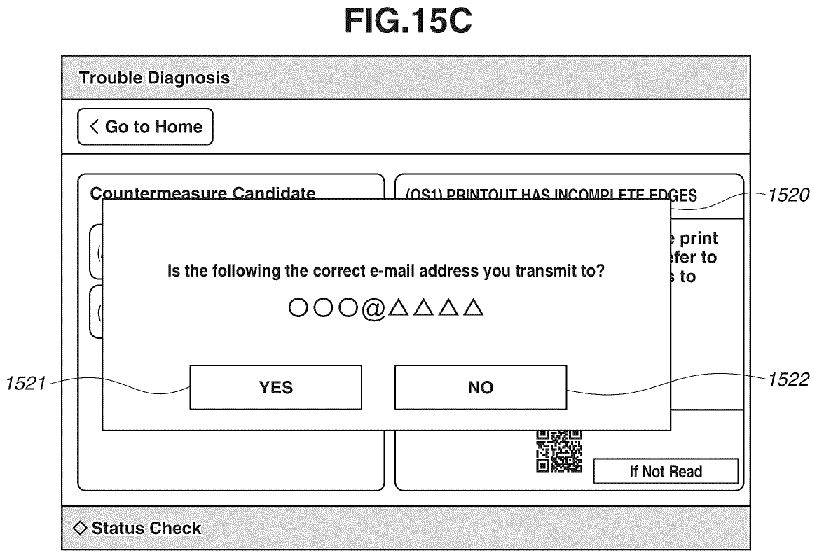

FIG. 14 and FIGS. 15A to 15C are a flowchart and pop-up display examples illustrating details of the transmission destination setting processing. The image forming apparatus 100 according to the present exemplary embodiment is an apparatus capable of user authentication. In step S1401, the CPU 110 checks whether the image forming apparatus 100 has been logged into using card authentication or the like. If the image forming apparatus 100 has been logged into (YES in step S1401), the processing proceeds to step S1402, and a pop-up 1500 prompting the user to configure settings using an expression like “Do you want to set an email address?” is displayed. In step S1403, the CPU 110 detects whether a “YES” button 1501 is pressed from the displayed pop-up 1500, and if the CPU 110 detects that the “YES” button 1501 is pressed (YES in step S1403), the processing proceeds to step S1404. In step S1404, the pop-up 1500 is closed, and in step S1405, an email address entry key 1510 is displayed. In step S1403, if a press of the “YES” button 1501 is not detected (NO in step S1403), the processing proceeds to step S1406. In step S1406, the CPU 110 detects whether a “NO” button 1502 is pressed from the pop-up displayed in step S1402. If the CPU 110 detects that the “NO” button 1502 is pressed (YES in step S1406), the processing proceeds to step S1407, and in step S1407, the pop-up 1500 is closed. The pop-up 1500 is continuously displayed until either of the buttons 1501 and 1502 is pressed.

In step S1408, the CPU 110 detects whether an “OK” button 1511 is pressed. If the CPU 110 detects that the “OK” button 1511 is pressed (YES in step S1408), the processing proceeds to step S1409. In step S1409, an email address is set based on the input information, and in step S1410, the email address entry key 1510 is closed. After the processing in step S1410 or the determination to be NO in step S1401, the processing proceeds to step S1411. In step S1411, the CPU 110 displays a pop-up 1520 using an expression like “Check the email address”. The displayed pop-up 1520 displays the email address obtained from the email address input key or authentication information registered in the storage unit 113. In step S1408, if a press of the “OK” button 1511 is not detected (NO in step S1408), the processing proceeds to step S1412. In step S1412, the CPU 110 detects whether a “cancel” button 1512 is pressed. If the CPU 110 detects that the “cancel” button 1512 is pressed (YES in step S1412), the processing proceeds to step S1413, and the email address entry key 1510 is closed.

In step S1414, the CPU 110 detects whether a “YES” button 1521 is pressed from the displayed pop-up 1520. If the CPU 110 detects that the “YES” button 1521 is pressed (YES in step S1414), the processing proceeds to step S1415, and the pop-up 1520 is closed. If a press of the “YES” button 1521 is not detected (NO in step S1414), the processing proceeds to step S1416. In step S1416, the CPU 110 detects whether a “NO” button 1522 is pressed from the displayed pop-up 1520. If the CPU 110 detects that the “NO” button 1522 is pressed (YES in step S1416), the processing proceeds to step S1417, and after the pop-up 1520 is closed, the processing returns to step S1405. The pop-up of the email address entry key 1510 is continuously displayed until either of the buttons 1511 and 1512 is pressed, and the pop-up 1520 is also continuously displayed until either of the buttons 1521 and 1522 is pressed.

While the method of inputting and setting a transmission destination email address using the email address entry key 1510 has been described in the present exemplary embodiment, a registration unit for registering a transmission destination email address in advance may be included. It is favorable to include a registration unit because a registered email address can be set as a transmission destination with one touch.

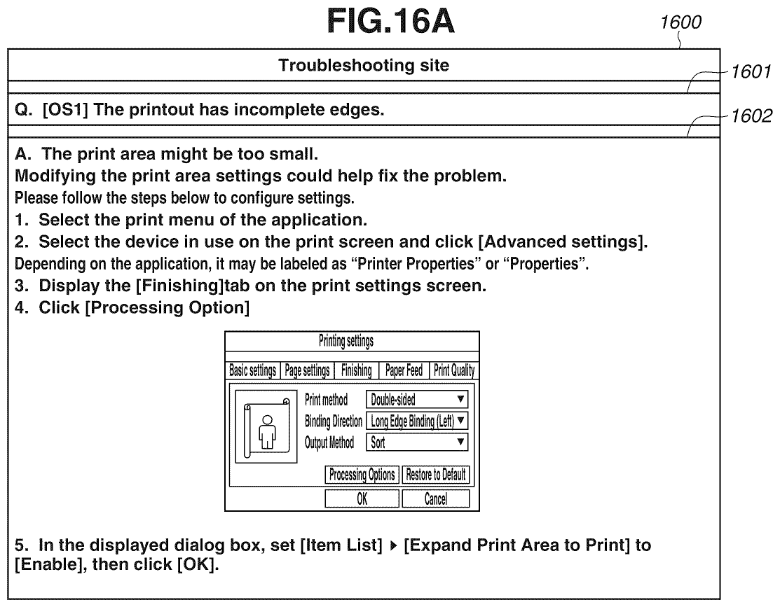

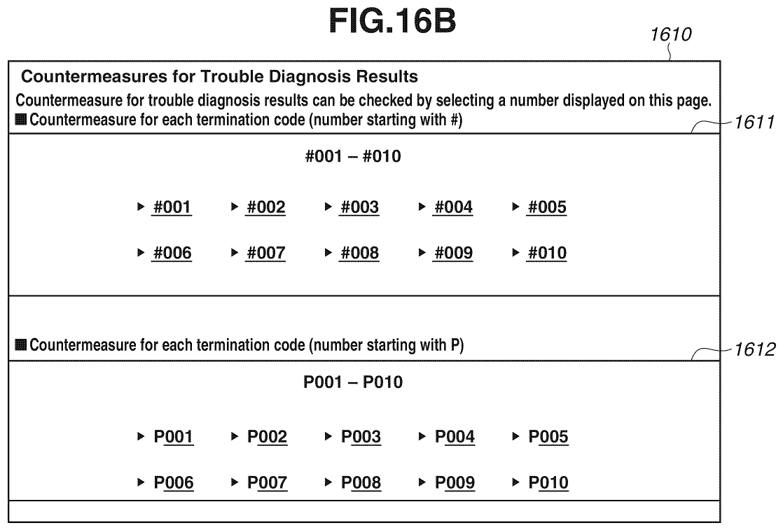

FIGS. 16A and 16B each illustrate an example site for troubleshooting.

FIG. 16A illustrates an example of a troubleshooting site displayed in access from the data transmitted in step S1213, and a display section 1600 includes a display section 1601 for displaying content related to a specific trouble and a display section 1602 for presenting a solution. FIG. 16B illustrates an example of a troubleshooting site displayed when the image 1111 of the two dimensional code is read. A display section 1610 displays a display section 1611 for displaying links that allow access to the countermeasure for each termination code based on the search key displayed in the details display section 1110. The display section 1610 further displays a display section 1612 that displays links that allow access to the countermeasure for each search code.

Here, as for each troubleshooting site example, FIG. 16A, which is different from FIG. 16B, illustrates the site that allows direct access to a specific trouble content. However, in order to provide a screen as shown in FIG. 16A for many diagnostic results, it is necessary to generate and store a display content for each diagnostic result on that screen. Therefore, providing a screen as shown in FIG. 16A, such as S1213, is more memory-efficient when used in cases where the diagnostic result is sent directly to a specified destination without generating a two-dimensional code. On the other hand, the display contents in FIG. 16B are independent of the diagnostic results and are common to multiple diagnostic results. The displayed sites and the respective access methods are merely examples, and the present exemplary embodiment is not limited to these.

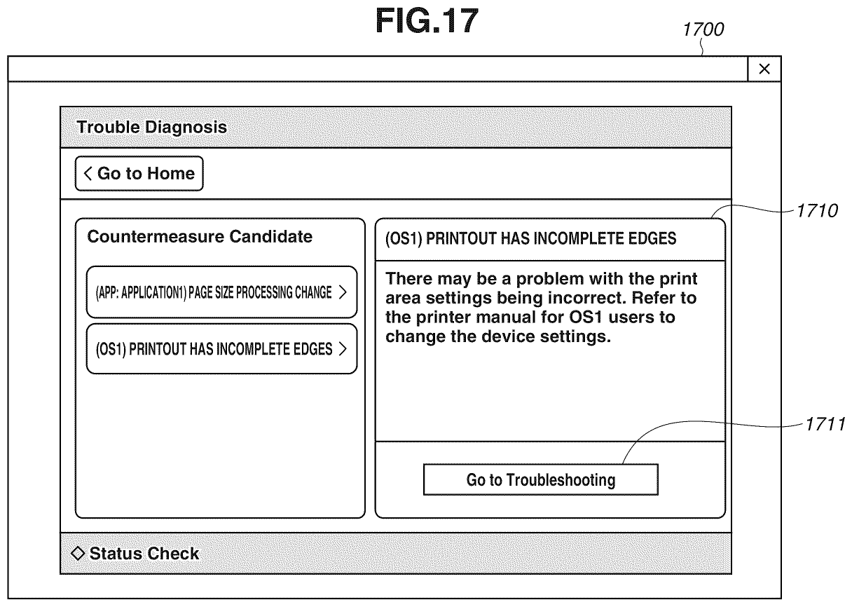

FIG. 17 is an example of displaying a details display section 1710 via a remote user interface (UI). The remote UI displays the operation unit 115 as a screen 1700 of the image forming apparatus 100 on a browser on the information processing apparatus 101 via the LAN 102. In a case of showing on the information processing apparatus 101, in the details display section 1710, a button 1711 is provided for transitioning to a site directly indicating troubleshooting, instead of a two dimensional code. The site example displayed is merely an example, and the present exemplary embodiment is not limited to this.

### Further Embodiments

In addition to the button 1112 as an option of FIG. 11, examples of options that the user can choose will be described in order to provide, to the user, information on a diagnostic result.

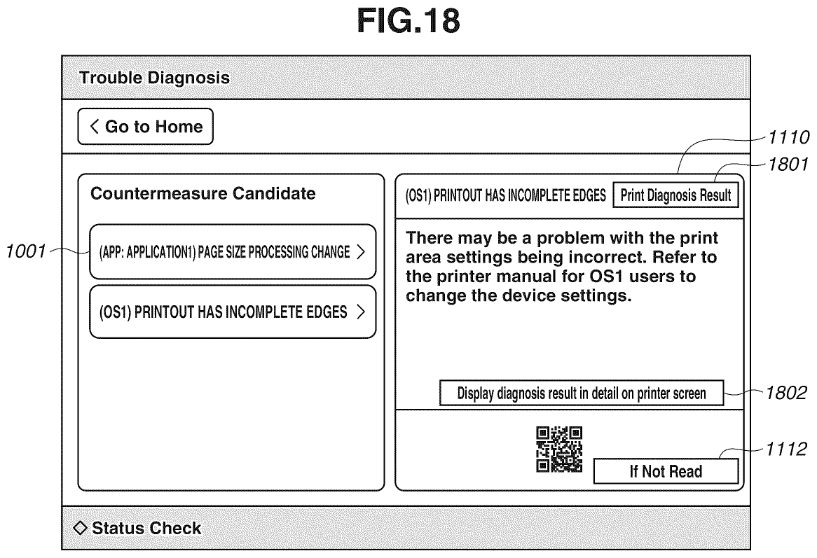

FIG. 18 illustrates a configuration with a button 1801 and a button 1802 provided on the display section of FIG. 11 displayed when one countermeasure candidate 1001 is selected. The button 1801 is used for “print a diagnosis result” and the button 1802 is used for “display a diagnosis result in detail on a printer screen”.

If the CPU 110 detects a print instruction through a press of the “print a diagnosis result” button 1801, the CPU 110 acquires the details of the diagnostic result from the storage unit 113 and executes printing on paper. The printed contents include information about the countermeasure displayed in FIG. 18, information about the diagnosis result, the QR Code®, and access information, such as a URL included in the QR Code®. Identification information and a network address of the image forming apparatus, information about a logged-in user who is operating, and another type of information may also be printed together.

If the CPU 110 detects that the button 1802 for “display a diagnostic result in detail on a printer screen” is pressed, the CPU 110 acquires details of the diagnostic result from the storage unit 113 and displays the details on the details display section 1110.

Depending on the diagnosis result, there are cases where data cannot be directly transmitted, and cases where it is easier to check details by displaying the details on a printer screen or printing the details. Thus, it is favorable to check the details of the diagnosis result by a plurality of means according to a configuration with, for example, sufficient memory. The means to display and acquire the details of the diagnosis result is merely an example, and the present exemplary embodiment is not limited to this. For example, with a server or another type of storage unit that stores detailed information, detailed information may be acquired via the LAN 102 instead of the storage unit 113.

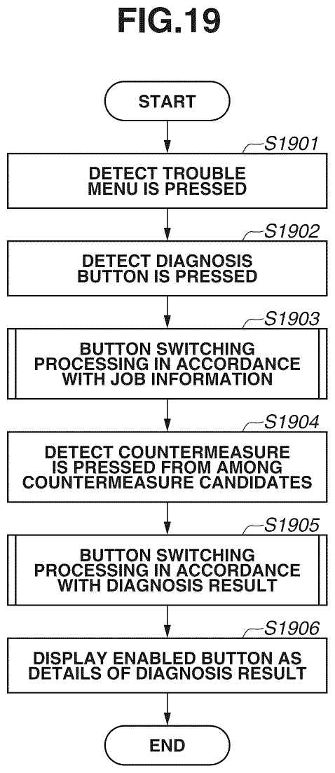

FIG. 19 is a flowchart illustrating a process of switching details buttons for a diagnostic result according to the diagnostic result or job information. In step S1901, the CPU 110 detects that the trouble menu 500 is pressed, and enables details buttons 1112, 1801, and 1802 for the diagnostic result. Here, “enabling” means displaying a button on the display section. In step S1902, the CPU 110 detects that a diagnosis button is pressed from the candidate job display section 600, and in step S1903, a button switching process corresponding to the job information is performed to disable a button that does not, or buttons that do not, need to be displayed. Here, “disabling” means that a button is not displayed on the display section. The processing in step S1903 will be described in detail below. In step S1904, the CPU 110 detects that a countermeasure is pressed from among countermeasure candidates, and in step S1905, a button switching process corresponding to the diagnostic result is performed. The processing in step S1905 will be described in detail below. In step S1906, the CPU 110 displays the enabled button(s), excluding the button(s) disabled in steps S1903 and S1905, as the details of the diagnostic result. It is favorable to switch between the button 1112, 1801, and 1802 depending on the diagnosis result or the job information from the viewpoint of usability for the user. The button-to-be-displayed switching method and the switching timings are merely examples, and the present exemplary embodiment is not limited to these. For example, as a switching method, the switching may be performed according to information about the image forming apparatus 100, such as disabling the “print a diagnosis result” button 1801 with no paper sheet or disabling the “if not read” button 1112 in a security environment in which an internet connection prohibition type is set, in addition to a diagnosis result and job information. Further, the “displayed” or the “not display” may be comprehensively determined by combining a diagnosis result and job information, or switching may be made between the display and the non-display with either a diagnosis result or job information, or based on one determination criterion.

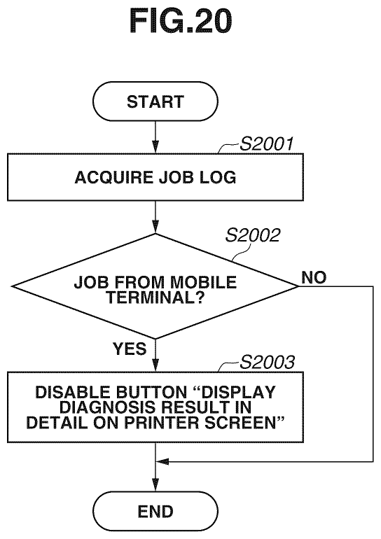

FIG. 20 is a flowchart of the button switching process (in step S1903) according to the job information. In step S2001, the CPU 110 acquires a job log from the job log DB 400. In step S2002, the CPU 110 determines whether the job is a job input from a mobile terminal based on the OS information in the job. If the job is a job input from a mobile terminal based on the OS information in the job (YES in step S2002), the processing proceeds to step S2003, and in step S2003, the “display a diagnostic result in detail on a printer screen” button 1802 is disabled. If the job is not a job input from a mobile terminal (NO in step S2002), the processing is ended. The switching of buttons according to OS information in a job is an example, and the present exemplary embodiment is not limited to this.

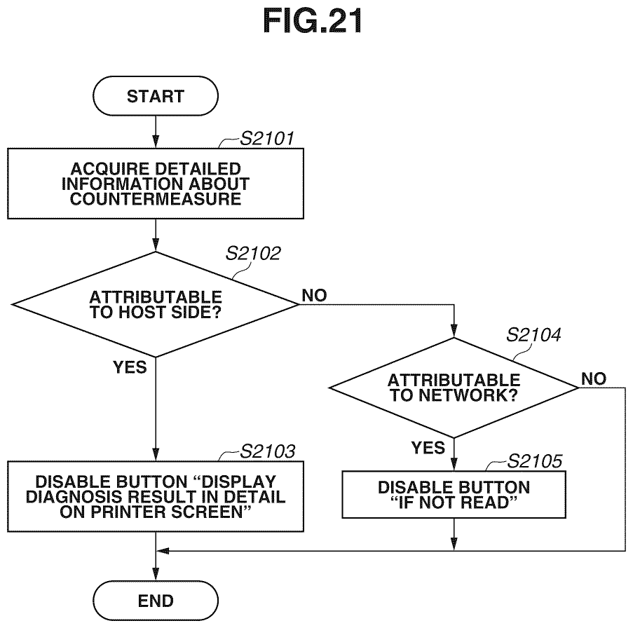

FIG. 21 illustrates a flowchart of the button switching process (in step S1905) according to the diagnostic result. In step S2101, the CPU 110 acquires detailed information on a countermeasure from the countermeasure list 1000. In step S2012, the CPU 110 determines whether the trouble is attributable to the host side from the detailed information on the countermeasure. If the trouble is attributable to the host side (YES in step S2102), the processing proceeds to step S2103 to disable the “display a diagnostic result in detail on a printer screen” button 1802. A trouble on the host side refers to a trouble that can be fixed only on the information processing apparatus 101 that generates print data, such as a diagnosis result determined to be “driver mismatch”. In step S2104, the CPU 110 determines from the details of the countermeasure whether the trouble is attributable to a network. In step S2102, if the trouble is not attributable to the host side, the processing proceeds to step S2104. In step S2104, if the trouble is attributable to a network (YES in step S2104), the processing proceeds to step S2105, and the “if not read” button 1112 is disabled. If the trouble is not attributable to a network (NO in step S2104), the processing is ended. Here, a network trouble refers to a trouble that data cannot be transmitted from the image forming apparatus 100 to the information processing apparatus 101, such as a diagnosis result that is determined to be “a trouble with the network environment”. The switching of the buttons according to the host side or the network trouble is an example, and the present exemplary embodiment is not limited to this switching.

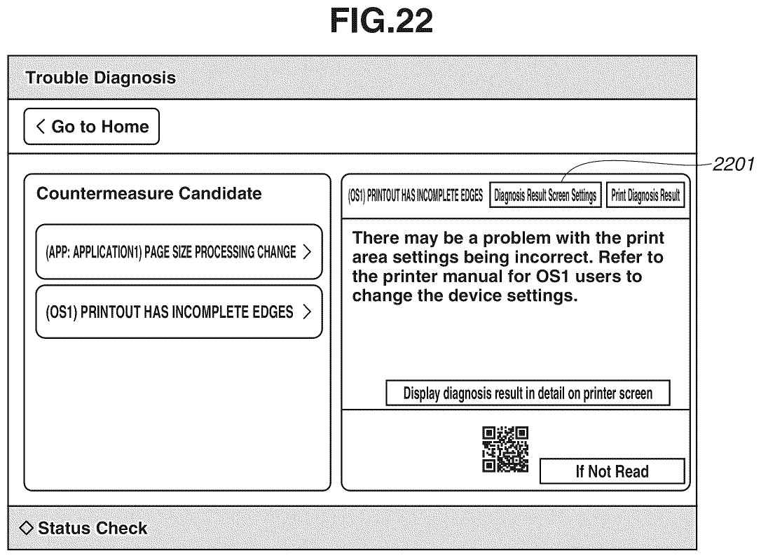

FIG. 22 is a diagram illustrating an example of a screen for setting the display of a diagnosis result. A “diagnostic result screen settings” button 2201 is provided on the display section of FIG. 11. For the user, the configuration in which the buttons 1112, 1801, and 1802 and the image 1111 of the two dimensional code can be enabled with settings is favorable from the viewpoint of usability. The screen to be displayed is merely an example, and the present exemplary embodiment is not limited to this example.

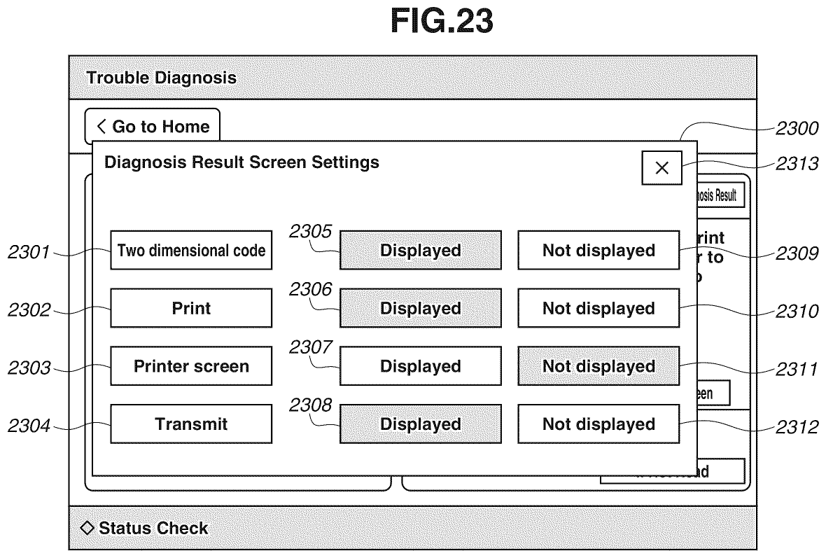

FIG. 23 is a diagram illustrating an example of a settings screen when the “diagnostic result screen settings” button 2201 is pressed. The CPU 110 detects a press of the “diagnostic result screen settings” button 2201, and displays a pop-up 2300 for setting the display of a diagnostic result. What is displayed here is display examples 2301, 2302, 2303, and 2304 corresponding to the image 1111 of the two dimensional code, the “if not read” button 1112, the “print a diagnosis result” button 1801, and the “display a diagnostic result in detail on a printer screen” button 1802, respectively, and “displayed” buttons 2305, 2306, 2307, and 2308 and “not displayed” buttons 2309, 2310, 2311, and 2312. In the example, the two dimensional code 2301 is set to be displayed with the “displayed” button 2305, the “print” button 2302 is set to be displayed with the “displayed” button 2306, the “printer screen” button 2303 is set not to be displayed with the “not displayed” button 2311, and the “transmission” button 2304 is set to be displayed with the “displayed” button 2308. The screen settings is closed with an “x” button 2313. The settings screen to be displayed is merely an example, and the present exemplary embodiment is not limited to this example.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-067931, which was filed on Apr. 19, 2024, and Japanese Patent Application No. 2024-176189, which was filed on Oct. 7, 2024, both of which are hereby incorporated by reference herein in their entireties.

What is claimed is:

1. An information processing apparatus comprising:
at least one processor; and
at least one memory that is in communication with the at least one processor, wherein the at least one memory stores instructions for causing the at least one processor and the at least one memory to:
execute a diagnosis of a trouble with the information processing apparatus;
control a display device to display a result of the diagnosis and a two dimensional code for displaying information on the result of the diagnosis; and
after the result of the diagnosis is displayed, transmit access information for displaying a page for providing information on the result of the diagnosis to a set transmission destination via a network.

2. The information processing apparatus according to claim 1, wherein the access information is changed according to the result of the diagnosis.

3. The information processing apparatus according to claim 1, wherein the diagnosis is executed based on selection of one or more diagnostic contents from a plurality of diagnostic contents.

4. The information processing apparatus according to claim 3, wherein the diagnosis is executed based on the selection of the one or more diagnostic contents and selection of one or more jobs from jobs executed by the information processing apparatus.

5. The information processing apparatus according to claim 1, wherein the access information is transmitted to the transmission destination associated with a user authenticated by the information processing apparatus.

6. The information processing apparatus according to claim 1, further comprising a printer configured to perform printing on paper.

7. The information processing apparatus according to claim 6, wherein the printer prints the result of the diagnosis on the paper based on a print instruction issued after the result of the diagnosis is displayed.

8. The information processing apparatus according to claim 1, wherein the at least one memory further stores instructions for causing the at least one processor and the at least one memory to:
further control the display device to display at least one option selectable by a user to provide the user with information on the result of the diagnosis, together with the result of the diagnosis and the two dimensional code.

9. The information processing apparatus according to claim 8, wherein the at least one option includes at least one of an option for transmitting access information for displaying a page for providing information on the result of the diagnosis to a set transmission destination via a network, an option for displaying the page for providing information on the result of the diagnosis on the information processing apparatus, and an option for printing the result of the diagnosis on paper by the information processing apparatus.

10. A control method for an information processing apparatus, the control method comprising:
executing a diagnosis of a trouble with the information processing apparatus;
controlling display of a result of the diagnosis and a two dimensional code for displaying information on the result of the diagnosis; and
transmitting, after the result of the result of the diagnosis is displayed, access information for displaying a page for providing information on the result of the diagnosis to a set transmission destination via a network.

11. A non-transitory computer readable storage medium storing a computer program for making a computer execute a method for an information processing apparatus, the method comprising:
executing a diagnosis of a trouble with the information processing apparatus;
controlling display of a result of the diagnosis and a two dimensional code for displaying information on the result of the diagnosis; and
transmitting, after the result of the diagnosis is displayed, access information for displaying a page for providing information on the result of the diagnosis to a set transmission destination via a network.
